(19) United States
(12) Patent Application Publication
(10) Pub. No.: US 2012/0174220 A1
(43) Pub. Date: Jul. 5, 2012

(54) DETECTING AND MITIGATING DENIAL OF SERVICE ATTACKS

(75) Inventor: John Rodriguez, Capitola, CA (US)

(73) Assignee: VeriSign, Inc., Dulles, VA (US)

(21) Appl. No.: 12/983,179

(22) Filed: Dec. 31, 2010

(51) Int. Cl. G06F 11/00

(52) U.S. Cl. 726/23

(57) ABSTRACT

Embodiments of this invention provide methods for detecting a denial of service attack (DoS) and isolating traffic that relates to the attack. The method may begin by collecting network traffic data by observing individual packets carried over the network. The data may then be compiled into a time series comprising network traffic data relating successive time-intervals. A difference value based upon the entry in the time series for a large time-window and for a small time-window. A deviation score may then be determined by calculating the ratio of the difference values. The deviation score may indicate whether an attack occurred. In an embodiment of the invention, an attack is deemed to occur if the deviation score is between 0.6 and 1.4.

### BACKGROUND OF THE INVENTION

A denial of service (DoS) attack directed at a networked computer system may reduce its functionality or make the system completely unavailable. A DoS attack works by sending a large number of requests to the computer system thereby increasing the load on the system, and impacting its performance. A small DoS attack may increase the processing time required for the system to respond to each request received, and may thereby decrease the perceived responsiveness of the system. A larger DoS attack may completely bring down the system by flooding network infrastructure such that some requests do not reach the designated target, or by flooding memory or processing capacity at computers responsible for responding to requests such that the requests time out before responses are sent or such that there is no memory available to cache the requests as they are received.

A DoS attack may be initiated from one or more powerful computers with ample bandwidth, or may be deployed in a distributed manner as a distributed denial of service (DDoS) attack from a number of computers. A DDoS attack is often deployed using a large number of compromised computers that are controlled from a central location. An attacker may obtain control over a large number of computers using a virus, a trojan or a worm which infects the target computer and permits the attacker to control it and instruct it to send requests over the Internet to a target computer system.

Since a DoS attack comprises traffic that may highly resemble or in some ways look exactly like traffic that is not part of the attack, it may be very difficult to detect and stop.

### BRIEF SUMMARY OF THE INVENTION

Embodiments of the invention provide methods for detecting a denial of service (DoS) attack on a networked device or network infrastructure by analyzing network traffic.

The process may begin by collecting network traffic information from a router, switch or server and compiling the information into a time-series. A time series may contain network-traffic information divided into successive time-periods. The time-series may for example be divided into one-second intervals, wherein the time-series contains one entry with network traffic information per time-period.

Each entry in the time-series may be analyzed to determine whether an attack occurred in that interval. A difference-value may be calculated with respect of two time-windows. In an embodiment of the invention, the difference value is the square of the difference of the respective value and the average value in the time-window.

Based on the two difference-values, a deviation-score may be computed by calculating the ratio of the difference-value for the small time-window to the difference-value for the large time-window. This value can be used to determine if an attack occurred. In an embodiment of the invention an attack is deemed to have occurred if the value is in the range of 0.6-1.4.

Once an attack has been detected the analysis may be repeated on a subset of the network traffic. If an attack is detected on one subset, but not another, the former may be subdivided again. Finally, once the traffic relating to the attack has been sufficiently isolated, this traffic may be blocked or isolated.

### BRIEF DESCRIPTION OF THE DRAWINGS

FIG. 1 shows various points from which network-traffic-data may be collected.

FIG. 2 shows a time-series with network-traffic-information for a number of categories, represented as s single time-series, or one per category.

FIG. 3 shows the time-series of FIG. 2 where some of the categories have been combined.

FIG. 4 shows a time series, an entry in the time series being analyzed, and two time-windows of different size wherein the small time-window and the large time-window end at the same point.

FIG. 5 shows a time series, an entry in the time series being analyzed, and two time-windows of different size wherein the small time-window is in the middle of the large time-window.

FIG. 6 shows a time series, an entry in the time series being analyzed, and two time-windows of different size wherein the small time-window and the large time-window start at the same point.

FIG. 7 shows a time series, an entry in the time series being analyzed, and a number of time-windows.

FIG. 8 shows a diagram of network traffic where some of the traffic has been identified as potentially relating to an attack and has been diverted to an isolated processing system.

FIG. 9 shows a diagram of network traffic where some of the traffic has been identified as potentially relating to an attack and has been blocked.

### DETAILED DESCRIPTION OF THE INVENTION

Embodiments of the present invention relate to methods for detecting and mitigating a denial of service (DoS) attack, including methods for collecting network traffic information, analyzing network traffic information, isolating traffic relating to a network attack, and determining information about the network attack.

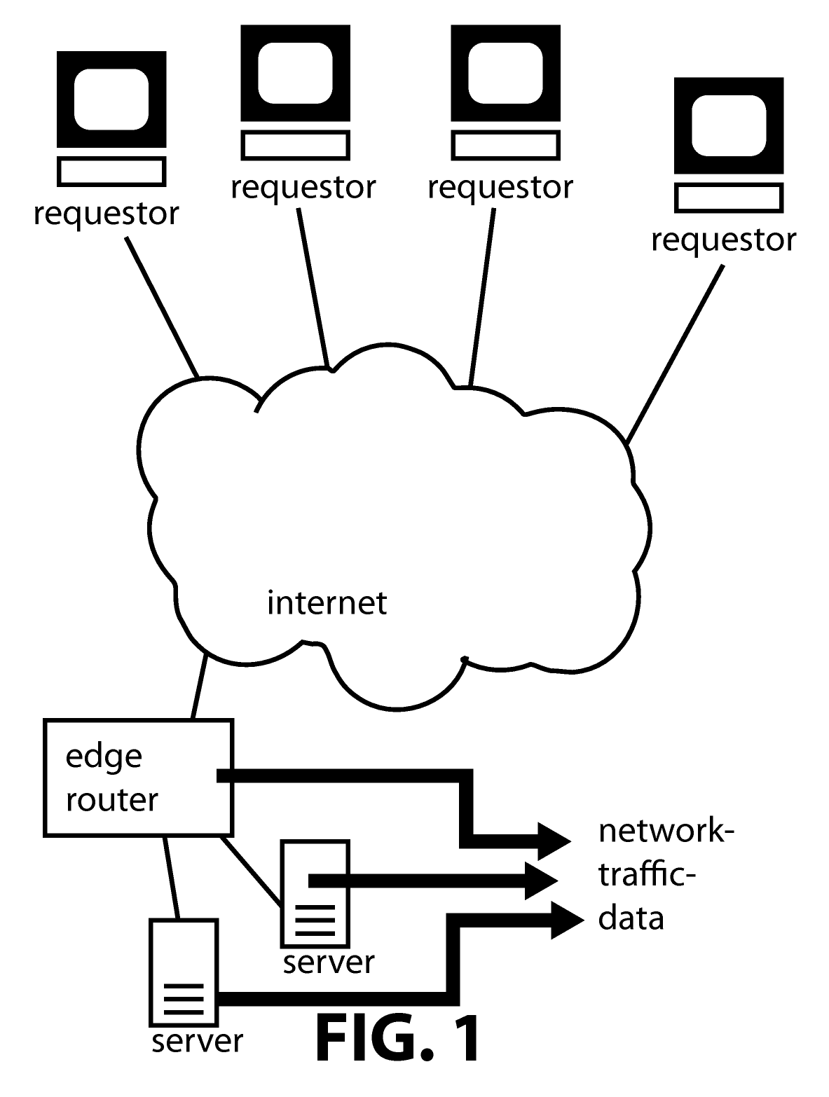

In an embodiment of the invention, network traffic data is collected from a network device, such as a switch or a router as shown in FIG. 1. The network data may be in the form of a table with information about network packets that pass through the device. The data may relate to all the packets the pass through the device or a subset of the traffic. The table may include columns to hold information about the time the packet was received or sent and information from the packet header, such as a source address, a destination address, a source port, a destination port, a packet length, a time-to-live value, the header checksum or other values based on header information. The table may also include information derived from the data carried in the packet. In some embodiments, a hash of the data contained in the packets, or a fuzzy hash of the data in the packet may be used. In other embodiments, information derived from protocols higher in the OSI model may be used. For example, for a packet containing a request to resolve a domain name in the domain name system (DNS), the data may include columns to indicate the domain name that was requested resolved, the types of DNS records that were requested (e.g. NS, A, MX), or the top level domain (e.g. .com, .net, .us) of the domain requested resolved. Similarly, when the packet is part of an HTTP request, the table may include columns to indicate the URL of the page requested, the hostname in the URL, the user-agent string of the browser, the state of the connection or other information in the HTTP request itself Network traffic information may also be collected from a computer processing requests received over the network as shown in FIG. 1. In such a case, the information collected may include information about the processing of the requests, including the time taken to process the request, information about resources used to respond to the request, information about how the request was processed, and information about the response sent. When the request is a request to resolve a domain name in the DNS system, this information may include information about the status of the domain name requested resolved such as whether it exists or not, how long it has been registered for, and how many requests to resolve it are received per day. When the request is a request for a web-page over the HTTP protocol, this information may include the server response code (e.g. 200-OK, 404-Not Found, 500-Server Error), whether the packet is consistent with the state of the connection, the size of the response or other information from the response.

Similar information may also be collected by inspecting network packets sent in response to requests received over the Internet or another network. This information could be collected from a computer processing the requests or from a network device such as a router or a switch. For example, by inspecting the responses to requests to resolve domain names in the DNS systems for IP addresses, it is possible to determine whether the domain exists by inspecting the packet containing the response to the request.

In high-volume applications it may be advantageous to collect traffic information from devices that are not responsible to responding to requests, such as routers or switches as opposed to computers responsible for processing the requests, database servers or devices similarly involved. This way, the data collection process does not impact the performance of the systems processing the requests, and in some implementations, specialized hardware in the network equipment may allow the data to be collected without impacting network performance at all or by only impacting it minimally.

Network traffic information may also be transmitted summarily. For example, if the only relevant information used is the source address and transmission time of each packet, the traffic information may be summarized as the number of packets with a particular IP address received in a particular interval (e.g. 12:55 am: 3 from 1.1.1.2, 2 from 1.1.1.3; 12:56 am: 9 from 1.1.1.2, 18 from 1.1.1.3).

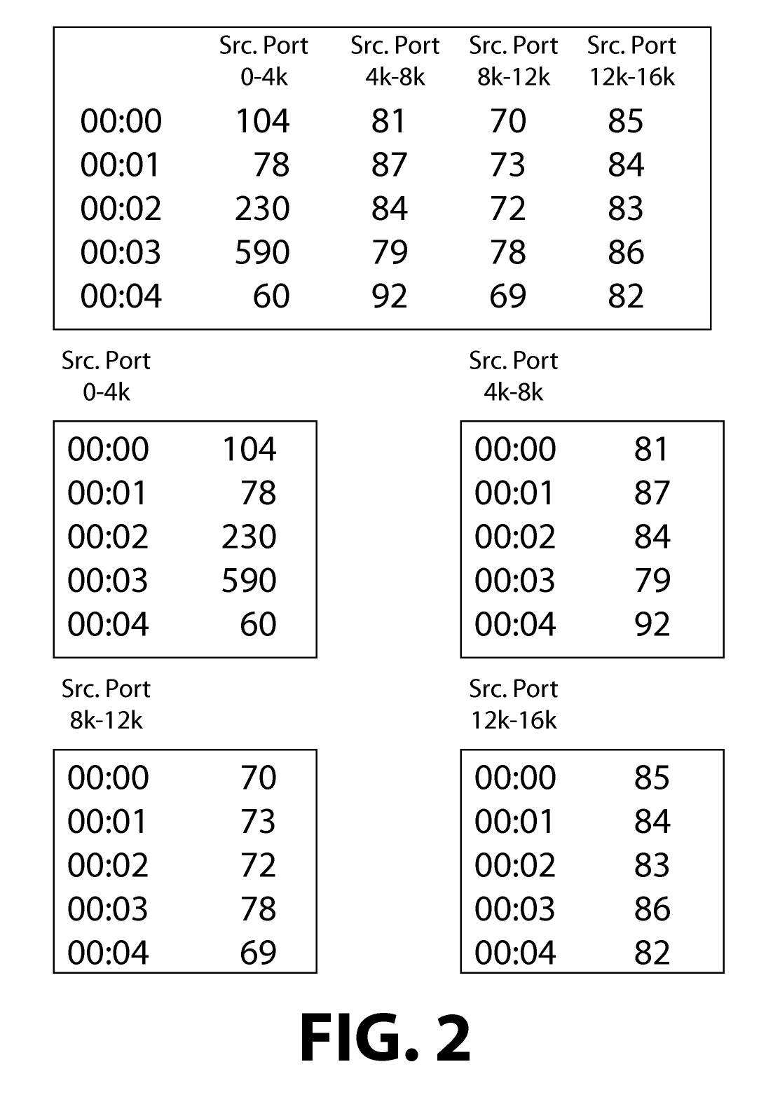

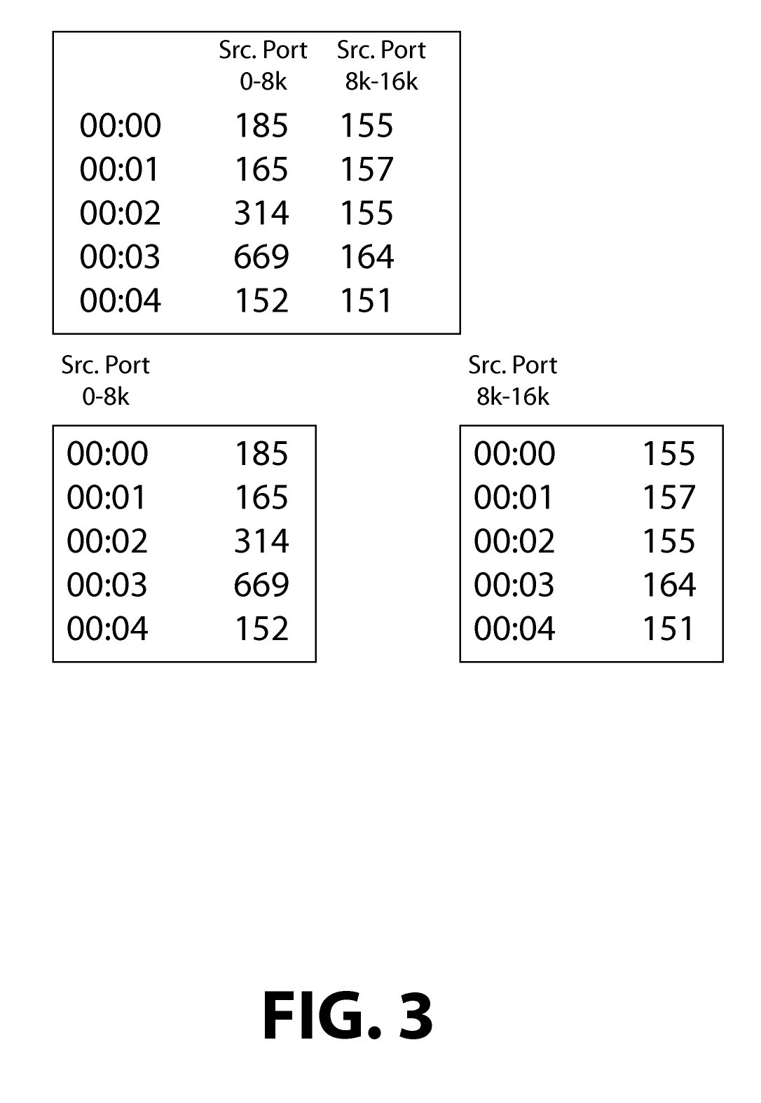

Network traffic information may be compiled into a time series as shown in FIGS. 2 and 3. A time series may contain information divided by a particular time interval. For example, a time series may be divided into one-second intervals. Such a time series may contain information about network traffic relevant to each interval. For example, a time series may contain information about network traffic from 19:00:00 to 19:01:00. The first interval may contain information relating to traffic between 19:00:00 and 19:00:01, the second interval information relating to traffic between 19:00:01 and 19:00:02 and so on. In an embodiment of the invention, the time series includes only a single metric, for example the total number of packets received:

| Interval | Total Requests |
|---|---|
| 19:00:00-19:00:01 | 150 |
| 19:00:01-19:00:02 | 1800 |
| 19:00:02-19:00:03 | 180 |

The time series may, as shown in the table above, include an indication of the interval to which each piece of network traffic information relates. This indication may be a range as shown above; or a start time, where the interval is deemed to be the interval between the start times of consecutive entries. A time series may also be compiled without such an indication where each piece of network traffic information is deemed to relate to a period of predetermined length. For example if a time series starts at 19:00:00, the 100^{th} entry may be deemed to start at 19:01:39 and end at 19:00:40.

A time series may contain network traffic information divided into a number of parameters. For example, for each interval, the time series may contain a number indicating the total number of requests received from each source IP address:

| Interval | 1.1.1.2 | 1.1.1.3 | 1.1.1.4 |
|---|---|---|---|
| 19:00:00-19:00:01 | 150 | 3 | 100,000 |
| 19:00:01-19:00:02 | 1,800 | 2 | 1,000 |
| 19:00:02-19:00:03 | 180 | 0 | 15,000 |

The network traffic information in the time series may be divided by any piece of information in the network traffic information used to compile the time series. The data in the time series may include the number of packets that conform to the particular class (e.g. a particular source IP address), or it may be devised otherwise. For example, the time series may show the total number of different IP addresses requests were received from or the number of different domain names that were requested to be resolved.

When representing network traffic information in a time series by number of requests received in a particular interval and dividing the data into categories, the categories may be defined by a single value. For example, each category may be a particular IP address. This approach may some times lead to a very large number of categories, and it can therefore be useful to group values together to form a single category. This may be done in a number of different ways.

If packets are assigned to groups based on the source IP address, the packets may be divided into two groups by the least significant bit, four groups by the two least significant bits, or eight groups by the three least significant bits. In another embodiment of the invention, the IP address space may be divided into 10 groups, such that addresses between 0.0.0.0 and 25.153.153.153 inclusive are assigned to the first group, addresses between 25.153.153.154 and 51.51.51.51 to the second group and so on.

Packets may be categorized based on a single value or based on a number of values. For example the packets may be grouped based on the source IP address and a domain name requested to be resolved. Depending on the type of value they may be grouped using a number of different methods to reduce the number of groups to a desired number.

Depending on how the network traffic data is received, the time series may be compiled in a number of different ways. If the traffic data is received as a table with an entry for each network packet, the time-series may be compiled with a map-reduce framework, such as the one made available by Google. A person skilled in the art will appreciate the variety of other methods that may be used to compile a time series based on such data. If the network traffic data received is summarized or already categorized, the categories may be combined by summing the various categories that are to be grouped, and summing across intervals if the time series is made with a larger time-interval than the time-interval which the network traffic data is compiled with.

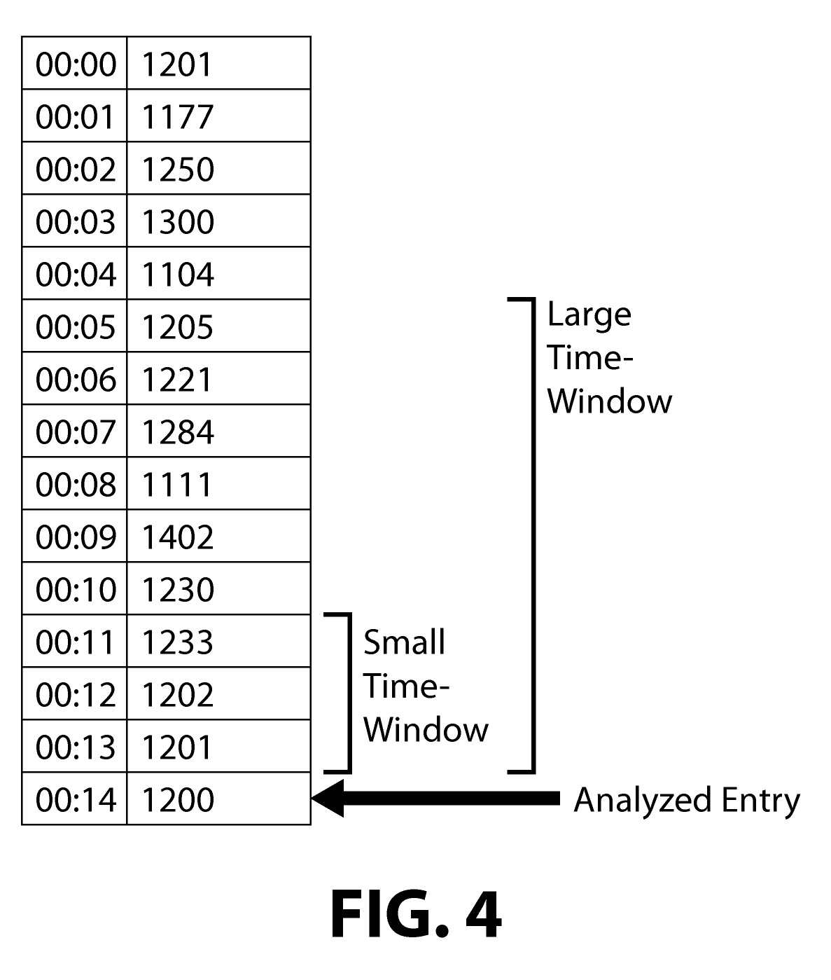

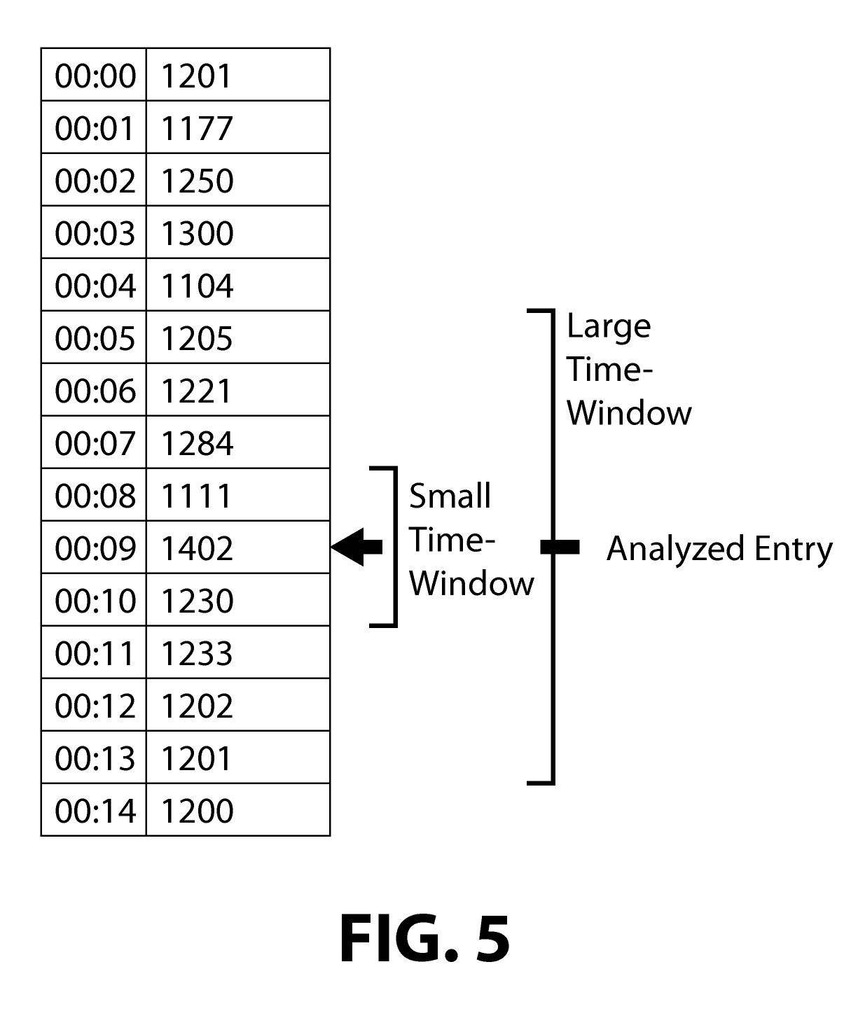

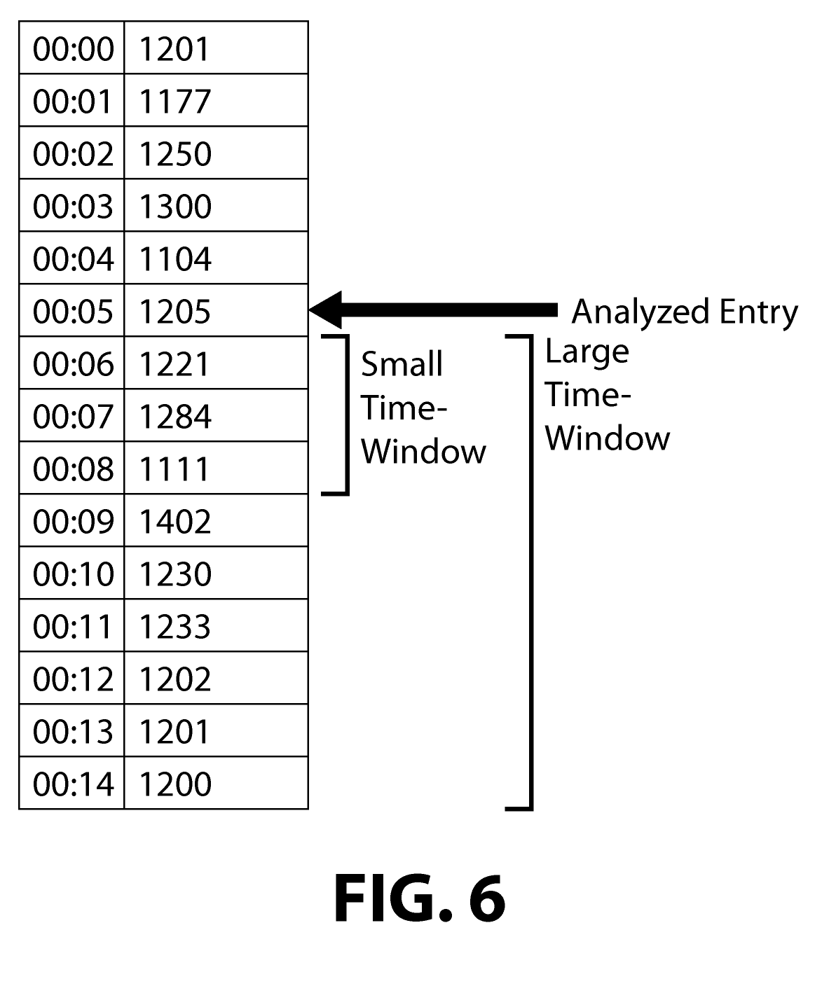

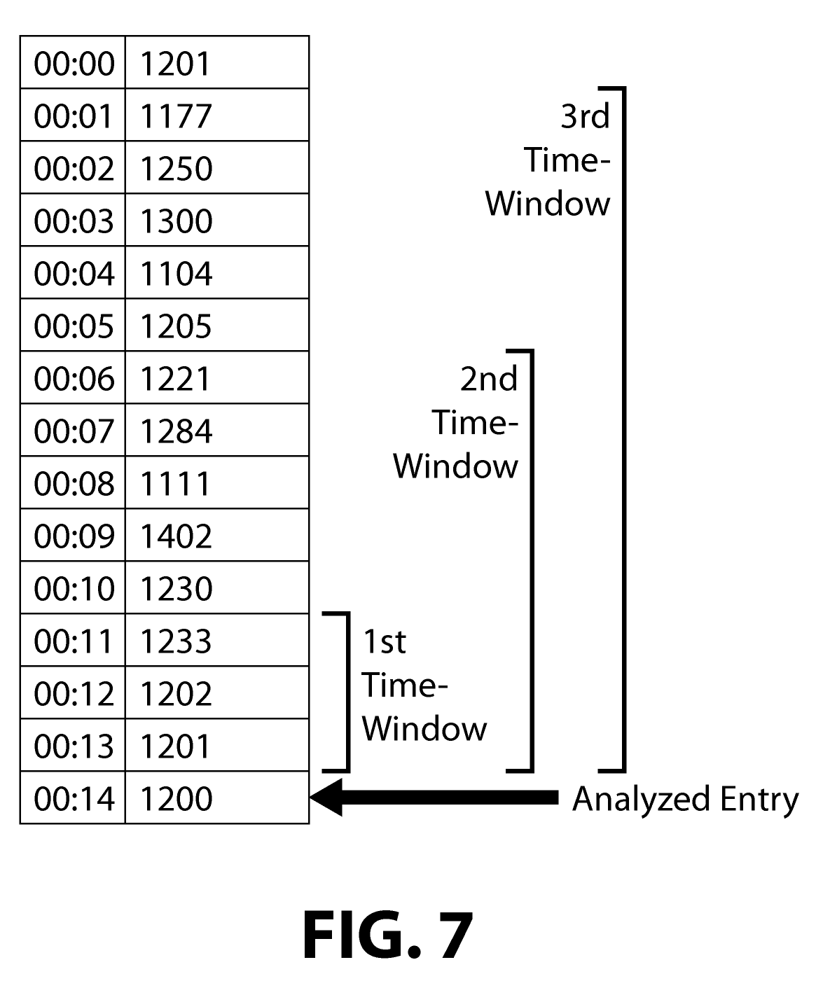

FIGS. 4 through 7 show time-windows and how they relate to a time-series and an entry in the time series being analyzed. When the entry being analyzed is changed, the time windows may move along with the entry being analyzed. For example if the entry being analyzed changes by a distance of one second, the start and end of each time window may move by the same amount.

Once a time-series is compiled, a difference-value may be computed for each entry in the time series for each of two or more time-windows. When using two time-windows of different sizes there will be a larger time-window and a smaller time-window. For example, if the time-series is divided into one-second intervals, the small time-window may be one minute, and the large time-window 100 minutes. Depending on the analysis applied, and the network traffic being analyzed more than two time-windows may be used, and the relative as well as the absolute sizes of the time windows used may vary.

In an embodiment of the invention, the difference-value is calculated by computing the square of the difference between the value in the time-series and the average value in the time-window. If the time-series is based on a one-second interval and the small time-window is 60 seconds, the difference-value would thereby be calculated by determining the average value in the time-window and subtracting it from the time-series entry being observed and squaring this difference.

In an embodiment of the invention the position of the time window is immediately prior to the value being studied such that if the entry for which a difference value is calculated is the entry relating to the period between 12:02:00 and 12:02:01, the values in the small time-window used to compute the average are those between 12:01:00 and 12:02:00. In this way, the value for which the difference value is being calculated does not affect the average value. In another embodiment, the value is immediately before the time-window. In yet another embodiment of the invention the relevant entry in the time series is at the very end, middle or very beginning of the time-window, but inside of it. The position of the value relative to the time window may render the method more or less effective for a particular application, and may vary based on the time of day, type of application, geographic origin or other properties of the traffic being studied. In some cases it may be useful to calculate a difference value based on a number of positions and run the analysis a number of times.

When two time-windows are used, a difference value is also calculated for the large time-window. The difference value is calculated in the same way for the large time-window as for the small time-window. The position of the large time-window relative to the small time window may impact the effectiveness of the invention. In an embodiment of the invention, the large time-window includes the small time window, and they both end at the same point in time. In another embodiment, the small time-window is immediately following the large time-window. In a further embodiment, the small time-window and the large time-window start at the same point in the time-series.

When there are more than two time-windows, they may be positioned relative to each other in a number of different ways as described above with respect to two time-windows.

The difference-value may be calculated in a number of ways in addition to the way described above. In another embodiment of the invention the difference-value may be calculated by calculating the absolute value of the difference between the respective value and the average value in the time-window. In a further embodiment, the difference-value may be calculated by calculating the absolute value of the difference between the respective value and the average value in the time-window and then dividing this by the average value in the time window. There are a number of ways to calculate the difference-value and variations may be tailored to the particular network application, protocol or system for which traffic is studied.

In an embodiment of the invention, network traffic is analyzed in real-time, and network traffic data is compiled as packets are received. This places a particular processing burden on the systems analyzing traffic, and a number of optimizations may be necessary to keep the analysis as near real-time as possible. When using the square of the difference between the respective value and the average value in the time-window as the difference value, the average value of each time window must be computed for each time-interval in the time-series, as all the time windows move one step ahead with each value in the time-series studied. One way to reduce processing requirements is to update these averages less frequently. For example if the small time-window is 60 seconds, the average value may only be updated for every 6-second step as opposed to for every 1-second step. The same step, or a different step may be used for the other time windows. If there are two time windows, one at 60 seconds and one at 6000 seconds, the small time-window may have a 6 second update interval and the large time-window may have a 600 second update interval. The impact of this optimization may vary with different types of network traffic based on the relevant protocol and traffic pattern, and there may be a need to tweak the update interval for a particular implementation.

Network traffic may also be processed in batches of varying size if real-time processing is not desirable, whether due to resources, the type of analytics available or for other reasons. Non real-time processing may enable the use of more complex algorithms to calculate the difference value and the deviation score. It may also allow for the use of a larger number of categories in the time series or a greater number of time series for analysis. When using non-real-time processing, network traffic may be processed in batches or varying sizes. The batches of traffic may then be processed in parallel by different threads on a single computer, by different computers, using a parallel computing cluster or by other means. In an embodiment of the invention, the Hadoop framework is used to facilitate the batch-processing of data in conjunction with the Google MapReduce framework. This configuration can be particularly useful for compiling time series from the network traffic data and for grouping data in a time-series together into categories.

Once a difference value has been determined for each time-window for a relevant entry in the time-series, a deviation score may be calculated. When there are two time-windows, this may be done by computing the ratio of the difference-value for the small time-window to the difference-value for the large time-window. The inverse ratio may also be used. A number of other metrics may also be used such as the difference-value for the small time-window divided by the square of the difference-value for the large time-window, the difference between the two values, or the difference between the two values divided by one of the two values. A person skilled in the art will appreciate the vast number of useful ways these two numbers may be combined to form a deviation score.

When more than two time-windows are used, the same type of analysis may be used, and the analysis may be used in relation to two time-windows at a time. In an other embodiment of the invention, more complex analysis may be performed on the more than two difference-values. For example, the variance of the difference-values can be computed and used to compute a deviation score. Various other statistical calculations may also be used on the difference-values to compute a deviation score.

In an embodiment of the invention, the network-traffic-data relating to each category is treated as a separate time-series and analyzed accordingly. For example, analysis may be performed on network-traffic-data for packets with a source IP-address in the range of 0.0.0.0-25.153.153.153; a sample time-series for such data may resemble the following:

| Interval | Requests from 0.0.0.0-25.153.153.153 |
|---|---|
| 19:00:00-19:00:01 | 1,871 |
| 19:00:01-19:00:02 | 13,567 |
| 19:00:02-19:00:03 | 27,876 |

Analysis may then subsequently be performed on the other categories for which data was compiled. If an attack is detected, the relevant data may be further studied. For example, if an attack is discovered when analyzing packets with a source address between 25.153.153.153 and 51.51.51.51, this network-data may then be divided into further categories that are in turn analyzed individually again. In an embodiment of the invention the current category may be divided further, such that the range of 25.153.153.153-51.51.51.51 is further divided into 10 ranges. In another embodiment of the invention, the traffic is analyzed with respect to a new set of categories, for example the source-port of the packet, the time-to-live value or a domain-name contained in the packet. Each time an attack is detected a new characteristic can be added to a list of criteria identifying traffic that is part of the attack. For example, if an attack is detected in traffic with a source address between 25.153.153.153 and 51.51.51.51 this can be added as a criteria. Similarly, if an attack is detected in traffic with a time-to-live value of exactly 127 hops this can be added as a criterion. The greater the number of criteria determined, the more precisely the attack can be defined. Accordingly, there is a smaller chance that the criteria devised also denote traffic that is not part of the attack.

An attack may be detected by observing that the deviation score is outside a particular range. In an embodiment of the invention this range is 0.6 to 1.4. In another embodiment of the invention, an attack may be detected by observing that the deviation score is within a particular range. The range used may vary based on the data being observed. For example one range may be used for analyzing traffic data relating to all requests received, whereas another range may be used when analyzing data relating to a particular range of source-addresses.

In an embodiment of the invention, traffic is monitored in real-time, or near real-time, by analyzing the aggregate number of packets received using methods described above, and analysis on subcategories of the data is only commenced once an attack is detected by analyzing the data relating to the aggregate packets received. In a different embodiment, analysis is conducted in real-time or near real-time based on network-traffic-data divided into a number of categories whether or not an attack has been detected otherwise. If one of the categories used aligns, fully or partially, with an aspect of network-traffic relating to an attack, the effect of the attack on the relevant deviation score may be much larger, and the attack may thereby be easier to detect, and it may also be detected earlier. It may therefore be useful to determine a set of categories to analyze whether or not an attack has been detected or not.

The computer resources required to process network-traffic-data will increase in proportion with the number of categories of network-traffic-data that is subjected to real-time or near real-time analysis. In an embodiment of the invention all traffic is analyzed, whether or not the data is processed in real time or in batches. Such a system may be required to maintain a throughput of data at the analysis infrastructure that is equal to the network traffic throughput. While a buffer, batch processing or a delay in processing may mitigate the resources needed to complete the necessary analysis, the available computing capacity will ultimately restrict the analysis that can be performed. It may therefore be necessary to consider the optimal number of resources to devote to this task and the optimal number of categories to subject to such analysis.

Once an attack is detected, and further analysis is conducted it may be advantageous to analyze a particular portion of the time-series or network-traffic-data in further detail. The same computing capacity constraints may not apply in such a scenario. If the portion of the time-series of network-traffic-data being analyzed is of a defined start and end, there will not be additional data to be analyzed flowing in, and more intensive analysis can be initiated and run until completion. The amount of computing capacity available will affect when the analysis completes, but it will be possible to complete a much more extensive analysis as the data being analyzed is limited and confined to a finite time-period. The only limiting factor on the analysis that can be completed may be the necessity to get the results of the analysis sooner. It may therefore be desirable to run the analysis in stages to obtain increasingly precise characteristics of the traffic that is part of the attack. As more information about the attack becomes available the mitigation efforts may change.

Initially, the knowledge that an attack is occurring may be used as a trigger for further analysis, and potentially diverting more capacity to the network resource under attack to mitigate any effect of the attack.

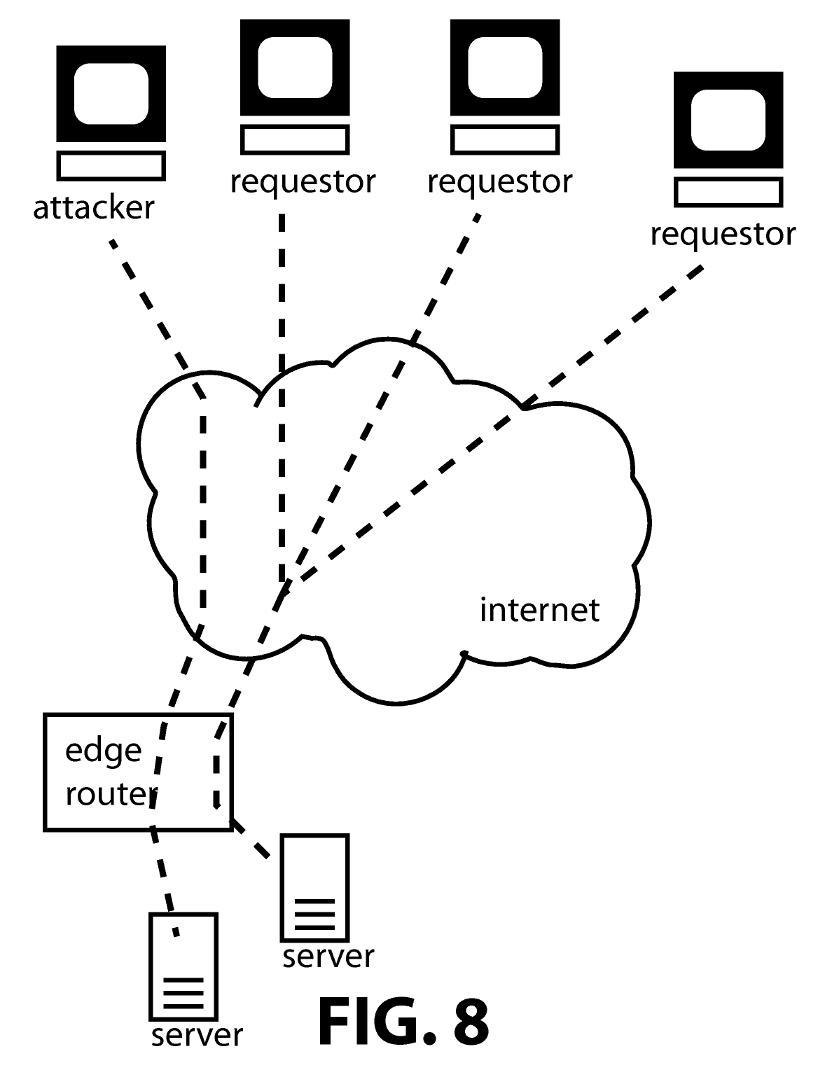

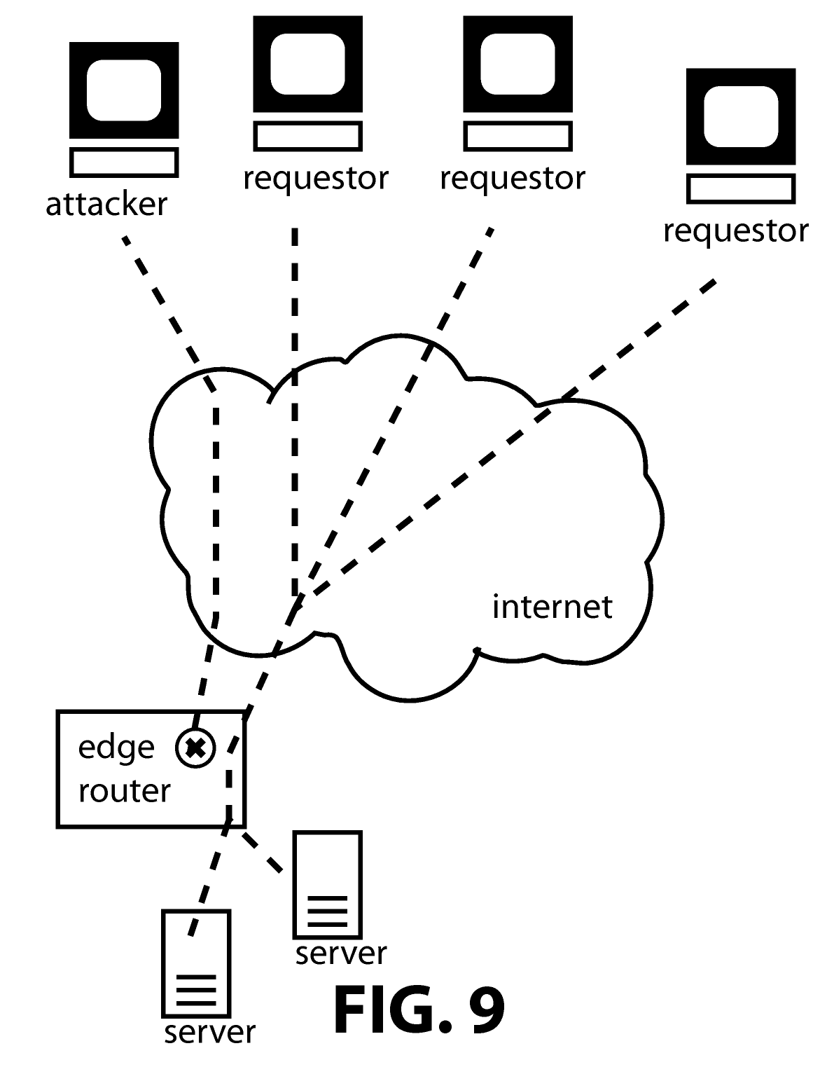

As more information about the traffic comprising the attack becomes available other forms of mitigation may become viable. In the case where criteria that define all or substantially all of the attack, but which also capture portions of traffic that are not part of the attack, are available it may be desirable to isolate the traffic defined by these criteria to an isolated system as shown in FIG. 8. In this way, a large portion of traffic, which is not described by these criteria will be unaffected by the attack. The traffic that is unrelated to the attack but is sent to the isolated system will still be served, but will be affected by the attack. As the available criteria become more precise it may be viable to block all or a portion of the traffic described by these criteria as shown in FIG. 9. This manipulation of the network traffic may be done automatically, or manually.

In another embodiment of the invention, the information obtained from the analysis can be used to manually analyze the attack. For example, for certain network applications it is not desirable to fail to respond to any request received. This may be due to the risk of denying service to a request that is not part of an attack being too great, due to contractual requirements to respond to all requests received, or for other reasons. In such a scenario, any traffic blocking that comes with a risk of blocking non-attack related traffic, whether manual or automatic may be unacceptable.

In cases where traffic manipulation or blocking is not acceptable, the results of such traffic analysis may nonetheless be used to prevent or mitigate the attack. By eliminating large portions of network traffic as unrelated to the attack, the amount of manual labor required to identify the sources of the traffic can be greatly reduced. DDoS attacks typically originate from a few thousand compromised computers, and if these can be identified it may be possible to have the computers taken offline by contacting the relevant Internet service provider (ISP) or computer owner. By further analyzing one or more compromised computers it may also be possible to identify further information about the source of the attack that is controlling the compromised computers or ways to disable the malicious code on them.

When initiating a DDoS attack it is common for the compromised computers to verify that they are able to connect to the target of the attack and to report back to the coordinator of the attack. When there are in excess of 1000 computers partaking in the attack, it may be possible to detect this initialization traffic using the methods described herein, and start combating the attack before it begins. An attack detected at such an early stage may be particularly suited to manual processing. Due to the low volume it may be possible to inspect a large amount of the suspect traffic manually to devise ways of combating the attack. In particular, if the suspect packets are very similar (e.g. they are all requests to resolve the same non-existent domain-name) or exhibit characteristics that strongly suggest an attack (e.g. the checksum or length are incorrect or the same) it may be viable to block future traffic with similar characteristics.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for detecting an attack on a computer network comprising:
generating a time series of data values derived from network traffic;
for each entry in the time series, calculating a difference-value, based upon a value in the entry and a number based upon other values in a time window, for a large time-window and a small time-window;
determining a deviation score for at least one entry in the time series by calculating the ratio of the difference-value for the small-window to the difference-value for the large window; and
for a point in the time series, determining that a network attack occurred within the small time-window by determining whether the respective deviation score is outside of a range of values.

2. The method of claim 1, further comprising:
based upon said step of determining that a network attack occurred, blocking a plurality of network packets.

3. The method of claim 1, wherein generating a time series of data values derived from network traffic comprises collecting traffic data from a network router.

4. The method of claim 1, further comprising:
sending an alert indicating that an attack is occurring.

5. The method of claim 1 wherein the range of normal values is about 0.6-1.4.

6. The method of claim 1 wherein calculating a difference-value for a value in a time series based on a time-window comprises calculating the square of the difference between the value and the average value in the time-window.

7. The method of claim 6 wherein the difference value is calculated in real-time as packets are received without updating the average value in each time-window for every packet received.

8. The method of claim 1 wherein the time series consists of pairs of data, each pair including:
a value indicating the number of packets received during a period, and
a value indicating the period of time during which the packets were received.

9. The method of claim 8 wherein the value indicating the period of time during which the packets were received is an integer indicating a number of seconds between a predetermined point in time and the start of the period, and the period is deemed to be one second long.

10. The method of claim 8 wherein the value indicating the number of packets received is determined by counting only those packets that meet a set of criteria.

11. The method of claim 10 wherein the set of criteria includes a criteria requiring a packet to contain a request to resolve a domain name.

12. The method of claim 11 wherein the set of criteria further includes a criteria requiring the domain name in the request to be a domain name that cannot be resolved.

13. The method of claim 10 wherein the set of criteria includes a criteria requiring a packet to contain one or more errors in the packet headers.

14. The method of claim 1 wherein the small time-window is contained within the large time-window.

15. The method of claim 1 wherein the small time-window is a period of time immediately following the large time-window.

16. The method of claim 1 wherein the large time-window is about 100 times the size of the small time-window.

17. The method of claim 1 wherein the small time-window is about 60 seconds.

18. The method of claim 1 further comprising:
for a field present in a plurality of network packets that are part of the network traffic, wherein the field in each packet can hold one of a plurality of values, determining the number of packets in which the field holds each value for packets received in the large time-window and packets received in the small time-window; and
for at least one of the plurality of values, based upon the number of packets containing the value were received in the small time-window and the number of packets containing the value were observed in the large time-window, determining that the at least one value indicates that a packet is a part of the attack.

19. The method of claim 18 further comprising:
blocking one or more incoming network packets that contain the at least one value.

20. The method of claim 18 wherein the field stores an origin IP address.

21. The method of claim 18 wherein the field indicates information about a protocol connection state.

22. The method of claim 18 wherein the field indicates whether a packet is consistent with the state of a connection which it is part of.

23. The method of claim 18 wherein the field indicates an HTTP user-agent string and a number of different HTTP user-agent strings are deemed to be the same value.

24. The method of claim 20 wherein all IP addresses within a particular range are deemed to be the same value.

25. The method of claim 18 wherein each of the plurality of network packets contains a request to resolve a domain name, and wherein the field holds the domain name.

26. The method of claim 25 wherein a dumber of different domain names are deemed to be the same value.

27. The method of claim 18 wherein the field holds a time to live value.

28. The method of claim 18 wherein the packet field holds a message size.

29. The method of claim 18 wherein the field holds information from which the geographic origin of the packet can be determined, and the country or origin is deemed to be the value.

30. The method of claim 1 further comprising:
assigning each of a plurality of network packets that are part of the network traffic to one of a plurality of categories;
for one of the plurality of categories, determining the number of network packets assigned to the category that were received in the small time-window and the number of network packets assigned to the category that were received in the large time-window;
determining that packets assigned to the category are part of the network attack.

31. The method of claim 1 further comprising:
determining a set of suspect IP addresses by determining the source IP addresses of packets that occurred in the small time-window, but which did not occur in the large time-window.

32. The method of claim 31 further comprising:
blocking traffic from the set of suspect IP addresses.
